(19) United States
(12) Patent Application Publication
(10) Pub. No.: US 2009/0082887 A1
(43) Pub. Date: Mar. 26, 2009

(54) Method and User Interface for Creating an Audio Recording Using a Document Paradigm

(75) Inventors: Frank L. Jania, Chapel Hill, NC (US); Terry Krause, Austin, TX (US); Darren M. Shaw, Hursley (GB)

Correspondence Address: CUENOT & FORSYTHE, L.L.C.;Kevin T. Cuenot, 20283 State Road 7, Ste. 300, Boca Raton, FL, 33498, US

(73) Assignee: INTERNATIONAL BUSINESS MACHINES CORPORATION, Armonk, NY (US)

(21) Appl. No.: 11/859,773

(22) Filed: Sep. 23, 2007

(51) Int. Cl. G06F 17/00

(52) U.S. Cl. 700/94

(57) ABSTRACT

A computer-implemented method of producing a sound recording can begin with receiving an audio signal. The method can continue with displaying the audio signal in a user interface as a waveform. Upon the waveform reaching an end of a line of the user interface, the waveform scrolls to a next line of the user interface. The method can include receiving a section break input. The method can further include beginning a continuation of the waveform on a new line of the user interface in response to receiving the section break input.

### FIELD OF THE INVENTION

The present invention relates to the field of computers and, more particularly, to computer-based production of audio recordings.

### BACKGROUND OF THE INVENTION

Existing computer-implemented methods of producing audio recordings are modeled after the operation of magnetic tape recorders including such functions as play, pause, and record buttons. These methods generally provide an editable view of the recorded waveform, which is typically a display of the waveform on a single timeline axis. Upon the waveform reaching an end of the single timeline axis, the waveform either compresses to allow all of the waveform to be displayed or, if the timescale does not compress, the left hand portion of the waveform disappears from view. Typically, a user can edit the waveform using cut and paste functions as well as selecting a portion of the waveform and applying an effect to it.

### BRIEF SUMMARY OF THE INVENTION

An embodiment of the present invention can include a method of producing a sound recording. The method can begin with receiving an audio signal. The method can continue with displaying the audio signal in a user interface as a waveform. Upon the waveform reaching an end of a line of the user interface, the waveform can scroll to a next line of the user interface. The method can include receiving a section break input. The method further can include beginning a continuation of the waveform on a new line of the user interface in response to receiving the section break input.

Another embodiment of the present invention can include a method of producing a sound recording. The method can begin with receiving an audio signal from a microphone in response to a user speaking into the microphone. The method can continue with displaying a waveform of the audio signal in a user interface as the audio signal is received. The waveform can scroll to a next line upon reaching an end of a line of the user interface. The method can include receiving a section break input and beginning a continuation of the waveform on a new line of the user interface in response to the section break input. The method further can include marking a beginning of the continuation of the waveform as a new section.

Yet another embodiment of the present invention can include a computer program product including a computer-usable medium having computer-usable program code that, when executed, causes a machine to perform the various steps and/or functions described herein.

### BRIEF DESCRIPTION OF THE SEVERAL VIEWS OF THE DRAWINGS

FIG. 1 illustrates a user interface in accordance with an embodiment of the present invention.

FIG. 2 is a flow chart illustrating a method of producing a sound recording in accordance with another embodiment of the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment, including firmware, resident software, micro-code, etc., or an embodiment combining software and hardware aspects that may all generally be referred to herein as a “circuit,” “module,” or “system.”

Furthermore, the invention may take the form of a computer program product accessible from a computer-usable or computer-readable medium providing program code for use by, or in connection with, a computer or any instruction execution system. For the purposes of this description, a computer-usable or computer-readable medium can be any apparatus that can contain, store, communicate, propagate, or transport the program for use by, or in connection with, the instruction execution system, apparatus, or device.

Any suitable computer-usable or computer-readable medium may be utilized. For example, the medium can include, but is not limited to, an electronic, magnetic, optical, electromagnetic, infrared, or semiconductor system (or apparatus or device), or a propagation medium. A non-exhaustive list of exemplary computer-readable media can include an electrical connection having one or more wires, an optical fiber, magnetic storage devices such as magnetic tape, a removable computer diskette, a portable computer diskette, a hard disk, a rigid magnetic disk, a magneto-optical disk, an optical storage medium, such as an optical disk including a compact disk-read only memory (CD-ROM), a compact disk-read/write (CD-R/W), or a DVD, or a semiconductor or solid state memory including, but not limited to, a random access memory (RAM), a read-only memory (ROM), or an erasable programmable read-only memory (EPROM or Flash memory).

A computer-usable or computer-readable medium further can include a transmission media such as those supporting the Internet or an intranet. Further, the computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber, cable, RF, etc.

In another aspect, the computer-usable or computer-readable medium can be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, microphones, audio interfaces, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

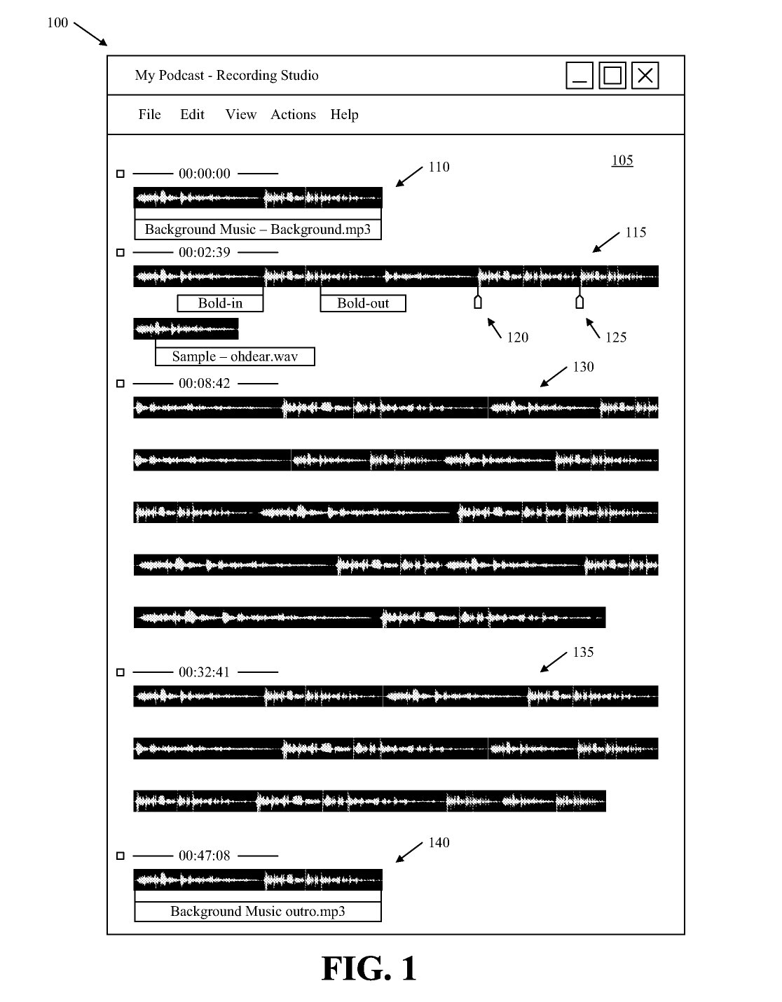

FIG. 1 illustrates a user interface 100 that can be used in accordance with an embodiment of the present invention. The top of the user interface 100 can include an exemplary file name “My Podcast” and an exemplary software title “Recording Studio.” While embodiments of the present invention can be particularly suited to producing podcasts, such embodiments also are suited to producing other recordings. Also, some other title can be used for the software. The second line of the user interface 100 includes selectable icons including “File,” “Edit,” “View,” “Actions,” and “Help,” which are top level headings for drop-down menus. Below the second line, the user interface 100 can include a waveform display area 105 that employs a document paradigm for displaying a recording as it is produced and for editing the recording during both production of the recording and post-production.

In one embodiment, a user speaks into a microphone that is coupled to a computer via an audio interface to produce an audio signal. The audio signal can begin displaying in the waveform display area 105 as a waveform 110 below an initial relative time of 00:00:00 (0 hours, 0 minutes, and 0 seconds). This initial section could be characterized as an introduction. The waveform 110 can be rendered and/or expand across the waveform display area 105 as time progresses. The user can choose to apply background music to the introduction as shown below the waveform 110 either during production of the recording, e.g., real-time, or at a later time, e.g., post-production.

At a relative time of 00:02:39 (2 minutes, 39 seconds), the user can select a new section input to begin a second waveform section 115. The new section input can be the enter key, which is similar to beginning a new paragraph in a word processing application. That is, the waveform display area can depict the waveform according to the document paradigm where, upon a user pressing the enter key or some other section break control, the waveform starts a new section. The enter key could be a logical break where the recording continues uninterrupted or it could be a recording break where the user selects “record” to begin recording again. The section break input further can cause the new section to be appended to an existing audio file, e.g., for the prior section, or be stored in a new file.

The second waveform section 115 may be categorized as an abstract. As in the introduction section, the waveform in the second waveform section 115 can expand across the waveform display area on a pre-determined time scale. The pre-determined time scale can be a default or it can be a user selected parameter. Upon reaching a line end, the waveform in the second waveform section 115 can scroll, or wrap-around, to a next line.

As the user produces the recording depicted in the second waveform section 115, the user can perform editing functions. For example, the user can choose to bold a section that begins at “bold-in” and ends at “bold-out.” Such a bold section may insert a phrase at the bold-in location and the same or another phrase at the bold-out location. For example, the phrase, “New news alert, new news alert!” can be inserted at the bold-in location and the phrase, “That was a new news alert, that was a new news alert!” can be inserted at the bold-out location. For example, such insertions can be included “in-line” with or replacing audio received from a microphone. Other editing examples can include inserting annotations 120 and 125, and inserting a sample such as “ohdear.wav” as shown. In that case, the annotations may cause the samples to play on another track so as not to replace any audio received from a microphone or other audio source. The annotations 120 and 125 can be notes or tags. For example, the annotations could be locator places for text to be displayed on a portable or other digital media player.

At a relative time of 00:08:42, the user can select enter to begin waveform section 130. Later, at a relative time of 00:32:41, the user can select enter again to begin waveform section 135. The waveform sections 130 and 135 can be characterized as body sections. At a relative time of 00:47:08, the user can select enter to begin waveform section 140, which could be characterized as a conclusion. As with the introduction and other sections, background music (e.g., “outro.mp3”) could be overlaid over the audio signal depicted by the waveform of the conclusion.

As discussed above, the user can begin a new section of the recording by choosing enter. Each new section can be up to the discretion of the user at the time the recording is being made. That is, the user can provide the section break input in real-time as the recording is made to create the section break. Alternatively, the recording might be made according to a template. For example, when using a template, the waveform section 110 can be pre-defined as an introduction where the background music would automatically be overlaid over the audio signal depicted by the waveform. Further, waveform sections 115, 130, 135, and 140 can be pre-defined as an abstract, two body sections, and a conclusion. The template may have waveform sections of length to be determined by the user. Alternatively, the template may have waveform sections of pre-defined durations or maximum durations.

As the user produces the recording depicted by the waveforms in the waveform display area 105, the user can choose several editing options in addition to those discussed above. The user might choose to delete a sequence immediately preceding a current cursor location by selecting “delete” or “backspace.” Such a deletion could delete a pre-determined amount of the recording, e.g., 30 seconds, an entire section, a line, etc., or it could delete the recording back to a most recent significant silence or other marker or annotation. The deletion can go back to a point in the recording and the system including the user interface 100 can wait for the user to begin recording again. Or, the deletion can go back to the point and begin recording from the point forward with no further input from the user. It should be appreciated that similar functionality can be implemented that deletes portions of audio after a cursor location during post-production, for example.

Another editing option that the user might choose is to increase or decrease the volume of the audio signal. Increasing loudness can be selected by pressing the up arrow and decreasing loudness could be selected by pressing the down arrow, for example. Such changes can affect audio at the current location of the cursor moving forward or a selected portion of the audio. For example, playback volume automation information can be recorded in real-time according to the arrow keys or other inputs. Yet another editing option that the user can choose is to highlight a section, which can apply a sound effect to the highlighted section such as by inserting background music. Highlighting can be selected by holding the space bar or other control while recording a sequence.

Additional editing options include defining an action for italicizing a section and employing hot keys to insert sound effects or stock sounds that may be included in the recording system. Hot keys refer to key combinations, such as <control><b> for bold, <control><i> for italicize, etc., that can be assigned to particular operations as described herein. For example, a hot key can be assigned to a function that, when activated while recording, inserts audio that plays over, or in conjunction with, the audio being recorded for as long as the hot key is active, e.g., the background.mp3 file playing in conjunction with waveform 110. When the hot key combination is no longer active, the background music can stop. It should be appreciated that fade-ins and fade-outs, or other transitional effects applied to the background.mp3, for example, also can be automatically inserted, e.g., according to the particular hot key combination used.

Hot key combinations also can cause the “bold-in” and “bold-out” tags to be applied to waveform 115. The particular functions applied to bolding may also be programmatically assigned, e.g., increase volume or play a lead-in sound effect at “bold-in”and a lead-out sound effect at “bold-out.” The example hot key combinations disclosed herein are presented for purposes of illustration only and are not intended to limit the embodiments disclosed herein or serve as an exhaustive listing of hot key functionality.

In addition to the editing actions discussed above, the user can select from several automatic editing functions. For example, the user can select an auto silence collapse function that reduces long periods of silence (e.g., silences greater than 5 seconds) detected in the received audio signal to shorter periods of silence (e.g., silences of 2 seconds). Or, for example, the user can select an auto garbage removal where the system listens for pause words such as “umm” or “ahh” and removes them. The auto garbage removal can be user specific where the user trains the system to listen for the pause words that the user typically uses. Another example of an automatic editing function is an auto speech recognition function that marks portions of the waveform with text from the audio signal. Such text markings could be used as “landmarks” for the user to find a particular sequence of the recording where the user wants to perform a post production editing operation.

Editing functions that are discussed above in terms of being applied during production of the recording, e.g., real-time, can also be performed post production. A particular post production editing function that a user may find beneficial is the ability to re-record a particular section of the recording. For example, the user can complete the recording depicted in the waveform display area 105 and decide that the waveform section 130 needs to be re-recorded. Such a re-recording could be done according to a fixed time so that it fits into the existing relative time slot or it could be done according to a flexible time where a next section begins whenever the re-recorded section ends.

The various section breaks allow entire sections or groups of sections to be edited, re-ordered, or the like as would a text document. In one embodiment, deletion of a section may cause audio occurring after the removed section to “snap” or move with respect to the timeline to fill the space once occupied by the removed audio. In another embodiment, the removal of audio may not cause later occurring audio to be relocated, but rather leave space available to record a replacement section.

A recording session employing the user interface 100 can produce a file that stores the recording. Such a recording can be saved in the file as an audio track that includes the audio signal depicted by the waveform and as an edit track that includes editing functions (e.g., section breaks, bold sequences, annotations, etc.). Further, the audio signal may be saved on multiple audio tracks where, for example, multiple people are contributing to the recording and each has their own microphone. The multiple audio tracks can be displayed in the waveform display area as a single waveform or they could be separated to show each audio track. In the latter situation, some editing functions can be adjusted so that the audio tracks are maintained in alignment. For example, deleting a sequence of a master audio track may also delete the corresponding sequences of the other audio tracks while deleting a sequence of a non-master audio track may insert silence on the non-master audio track for the deleted sequence.

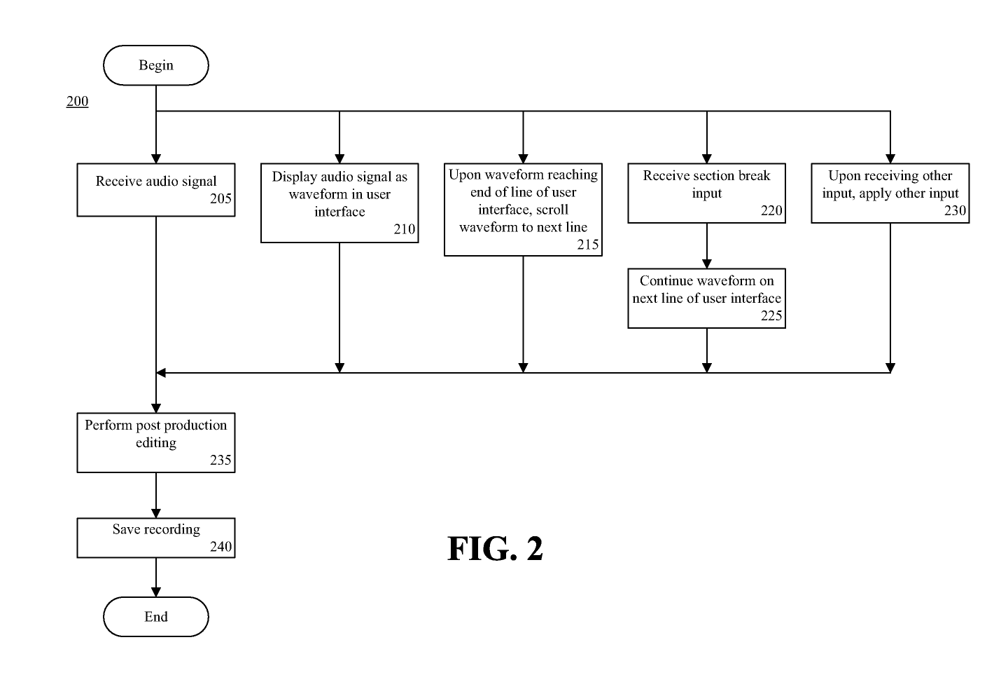

FIG. 2 is a flow chart illustrating a method 200 of producing a sound recording according to an embodiment of the present invention. The method 200 can begin with receiving an audio signal in step 205. For example, a user producing a recording can speak into a microphone that is coupled to a computer to produce the audio signal.

The method 200 can continue in step 210, which displays a waveform of the audio signal in a user interface as the audio signal is received. For example, the waveform can be displayed in the waveform display area 105 of the user interface 100 of FIG. 1. In step 215, the method 200 can scroll the waveform to a next line of the user interface upon the waveform reaching an end of a line of the user interface. In step 220, the method 200 can include receiving a section break input. For example, the user can select the section break input by pressing the enter key. In step 225, the method 200 can include continuing the waveform on a new line of the user interface upon receiving the section break input. The new line can start a new section of the recording.

In step 230, the method 200 can further include applying other input to the recording upon receiving the other input. The other input can include a delete input, a highlight input, a stylization input, e.g., italicize on/off, bold on/off, etc., a hot key input, a sound level input, an annotation input, an auto collapse input, an auto garbage removal input, and a speech recognition input. Examples of such inputs are discussed above relative to the user interface 100 of FIG. 1. In step 235, a user can perform post production editing of the recording. And, in step 240, the user can save or otherwise output the recording. As used herein, “output” or “outputting” can mean, for example, writing to a file, writing to a user display or other output device, playing audio, sending or transmitting to another system, exporting, or the like.

The flowchart(s) and block diagram(s) in the figures illustrate the architecture, functionality, and operation of possible implementations of systems, methods and computer program products according to various embodiments of the present invention. In this regard, each block in the flowchart(s) or block diagram(s) may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagram(s) and/or flowchart illustration(s), and combinations of blocks in the block diagram(s) and/or flowchart illustration(s), can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to the embodiments thereof, it will be apparent that modifications and variations are possible without departing from the scope of the invention defined in the appended claims.

What is claimed is:

1. A computer-implemented method of producing a sound recording, the method comprising:
receiving an audio signal;
displaying the audio signal in a user interface as a waveform, the waveform scrolling to a next line upon reaching an end of a line;
receiving a section break input; and
beginning a continuation of the waveform on a new line of the user interface in response to the section break input.

2. The method of claim 1, wherein the audio signal comprises a voice signal.

3. The method of claim 1, wherein the user interface comprises a waveform display area.

4. The method of claim 1, further comprising receiving a delete input and deleting a pre-determined amount of the waveform at a cursor location.

5. The method of claim 1, further comprising receiving a highlight input and highlighting a portion of the waveform.

6. The method of claim 1, wherein displaying the audio signal in the user interface takes place as the audio signal is received.

7. The method of claim 1, further comprising receiving a style input and inserting a style begin mark at a first cursor location.

8. The method of claim 7, further comprising receiving an un-style input and inserting a style end mark at a second cursor location.

9. The method of claim 1, further comprising receiving a hot-key input.

10. The method of claim 9, wherein the hot-key input specifies a sound effect, wherein the method further comprises inserting the sound effect at a cursor location.

11. The method of claim 1, further comprising receiving an auto collapse input and collapsing a period of silence of a particular duration into a period of silence of a shorter duration.

12. The method of claim 1, further comprising receiving an auto garbage removal input and removing pause words.

13. The method of claim 1, further comprising receiving a sound level input and adjusting the sound level beginning at a cursor location.

14. The method of claim 1, further comprising receiving text information and inserting the text information at a cursor location.

15. The method of claim 1, further comprising applying speech recognition to the audio signal to produce textual information and marking the waveform with the textual information.

16. A computer-implemented method of producing a sound recording, the method comprising:
receiving an audio signal from a microphone in response to a user speaking into the microphone;
displaying a waveform of the audio signal in a user interface as the audio signal is received, the waveform scrolling to a next line upon reaching an end of a line of the user interface;
receiving a section break input;
beginning a continuation of the waveform on a new line of the user interface in response to the section break input; and
marking a beginning of the continuation of the waveform as a new section.

17. The method of claim 16, further comprising receiving a delete input and deleting a pre-determined amount of the waveform at a cursor location.

18. A computer program product comprising a computer-usable medium comprising computer-usable program code that implements a method of producing a sound recording, the computer-usable medium comprising:
computer-usable program code that receives an audio signal;
computer-usable program code that displays the audio signal in a user interface as a waveform and that scrolls the waveform to a next line upon reaching an end of a line;
computer-usable program code that receives a section break input; and
computer-usable program code that begins a continuation of the waveform on a new line of the user interface in response to the section break input.

19. The computer program product of claim 18, wherein the user interface comprises a waveform display area and menus.

20. The computer program product of claim 18, further comprising computer-usable program code that marks a beginning of the continuation of the waveform as a new section.
